(19) United States
(12) Patent Application Publication
(10) Pub. No.: US 2010/0329448 A1
(43) Pub. Date: Dec. 30, 2010

(54) Method for Secure Evaluation of a Function Applied to Encrypted Signals

(76) Inventors: Shantanu D. Rane, Cambridge, MA (US); Wei Sun, Waterloo (CA); Anthony Vetro, Arlington, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/495,721

(22) Filed: Jun. 30, 2009

(51) Int. Cl. H04L 9/28

(52) U.S. Cl. 380/28

(57) ABSTRACT

Embodiments of the invention describe a system and a method for determining securely a result of applying a function to a first encrypted signal and a second encrypted signal resulted from encrypting a first signal and a second signal respectively, The method expresses the function as a linear combination of homomorphic components, wherein a homomorphic component is an algebraic combination of the first signals and the second signal such that an encrypted result of the algebraic combination is suitable to be calculated directly from the first encrypted signal and the second encrypted signal using homomorphic properties. Next, the method determines encrypted results of the homomorphic components from the first encrypted signal and the second encrypted signal, and combines the encrypted results of the homomorphic components according to the linear combination to produce the encrypted result of the function. The method is executed by a plurality of processors.

### FIELD OF THE INVENTION

This invention relates generally to secure evaluation of a function applied to two or more encrypted signals, and more particularly to determining an encrypted result of a homomorphically transformable function of two encrypted signals.

### BACKGROUND OF THE INVENTION

It is often required to securely determine a result of a function applied to encrypted signals. For example, a difference between two encrypted signals can be measured using a variety of functions, such as squared error, or Hamming distance.

Conventional methods typically use cryptographic hash functions to determine whether two signals are different. If the hashes of signals x and y are equal, then the signal x is the same as the signal y, assuming that hash collisions occur with a negligibly low probability. Such a comparison of cryptographic hashes is fundamental in most password and key management applications.

An essential property of conventional cryptographic hash functions is that the hash functions do not preserve the underlying structure of the signals that are evaluated. Specifically, even if two signals are mostly similar, except for some noise, then the cryptographic hashes of the two mostly similar signals are vastly different, even if the noise is very small. Therefore, a cryptographic hash function cannot, by itself, be used for evaluating the similarity of signals in noisy environments, e.g., storage devices and communication channels. For the same reason, cryptographic hash functions cannot be used to determine differences between two signals, because a small difference between the signals results in a large difference between the respective cryptographic hashes.

Evaluating signals in a secure manner is important in many applications. For example, private medical data are often analyzed and classified by a third party. It is important that the private medical data are not revealed to the third party. In addition, the third party does not want to reveal the classification method, nor the database used for the classification.

This problem is often defined as a secure multiparty computation (SMC). Computationally secure methods, such as oblivious transfer (OT), secure inner product (SIP) can be used as primitives to perform more complicated operations. U.S. patent application Ser. No. 11/005,293 describes such a method. That method performs object detection without revealing the image supplied by a user to a classifier. Similarly, the classification method used by classifier is not revealed to the user. However, that method requires a large number of exchanges between the user and the classifier. The communication overhead, in terms of exchanges and key management, is very large.

### SUMMARY OF THE INVENTION

It is an object of present invention to provide a system and a method for securely determining a result of a function applied to signals.

Embodiments of the invention are based on the realization that homomorphically transformable functions of signals have specific properties, which facilitate finding a solution of those functions in an encrypted domain. The homomorphically transformable function of a first signal and a second signal is a function that can be transformed into a linear combination of homomorphic components. A homomorphic component is an algebraic combination of inputs, i.e., signals, such that the encrypted value of the homomorphic component can be calculated directly, i.e., without decryption, from the encrypted values of the signals. Thus, the computation of the encrypted results of the homomorphic components is performed in the encrypted domain preserving the secrecy of the signals.

An encrypted homomorphic component can be processed using homomorphic properties. Examples of homomorphic components include, but are not limited to, a function of the first signal, a function of the second signal, a linear function of a product of the first and the second signals, and so on. For example:

Squared distance function: d(x, y)=(x−y)²=x²+y²−2xy, where x and y are real numbers or integers. The square root of d(x, y) is termed as the Euclidean distance between the signals x and y.

Hamming distance function: d(x, y)=x+y−2xy, where x and y are binary numbers i.e., take values 0 or 1.

Some arbitrary function: f(x, y)=sin(x)+cos(y)+4x²y³.

Embodiments of the invention describe a system and a method for determining securely a result of applying a function to a first encrypted signal and a second encrypted signal resulted from encrypting a first signal and a second signal respectively, The method expresses the function as a linear combination of homomorphic components, wherein a homomorphic component is an algebraic combination of the first signals and the second signal such that an encrypted result of the algebraic combination is suitable to be calculated directly from the first encrypted signal and the second encrypted signal using homomorphic properties. Next, the method determines encrypted results of the homomorphic components from the first encrypted signal and the second encrypted signal, and combines the encrypted results of the homomorphic components according to the linear combination to produce the encrypted result of the function. The method is executed by a plurality of processors.

### BRIEF DESCRIPTION OF THE DRAWINGS

FIG. 1 is a block diagram of a method for securely determining an encrypted result of a homomorphically transformable function applied to two encrypted signals according to an embodiment of the invention;

FIGS. 2-3 are block and activity diagrams of a method for determining an encrypted difference between two signals according to an embodiment of the invention; and

FIG. 4 is schematic of a method for secure difference calculation for biometric authentication according to another embodiment of the invention.

### DETAILED DESCRIPTION OF THE PREFERRED EMBODIMENT

Embodiments of the invention are based on the realization that some functions have specific properties, which facilitate finding results of those functions when applied to encrypted signals. For the purpose of this specification and appended claims, we define these functions as homomorphically transformable functions.

A homomorphically transformable function is a function that can be transformed into a linear combination of homomorphic components. As defined herein, a homomorphic component is an algebraic combination signals, such that an encrypted result of the homomorphic component can be calculated directly, i.e., without decryption, from the encrypted signals. Thus, the computation of the encrypted results of the homomorphic components preserves the secrecy of the signals.

The encrypted homomorphic component can be processed using homomorphic properties. Examples of the homomorphic component are a function of the first signal, a function of the second signal, and a linear function of a product of the first and the second signals.

Some examples of a homomorphically transformable function are:

Squared distance function: d(x, y)=(x−y)²=x²+y²−2xy, where x and y are real numbers or integers. As before, the square root of d(x, y) is the Euclidean distance between the signals x and y.

Hamming distance function: d(x, y)=x+y−2xy, where x and y are binary numbers i.e., take values 0 or 1.

Some arbitrary function: f(x,y)=sin(x)+cos(y)+4x²y³ or f(x, y, z)=sin(x)+sin(y)+sin(z).

Examples of processing using the homomorphic properties are described below.

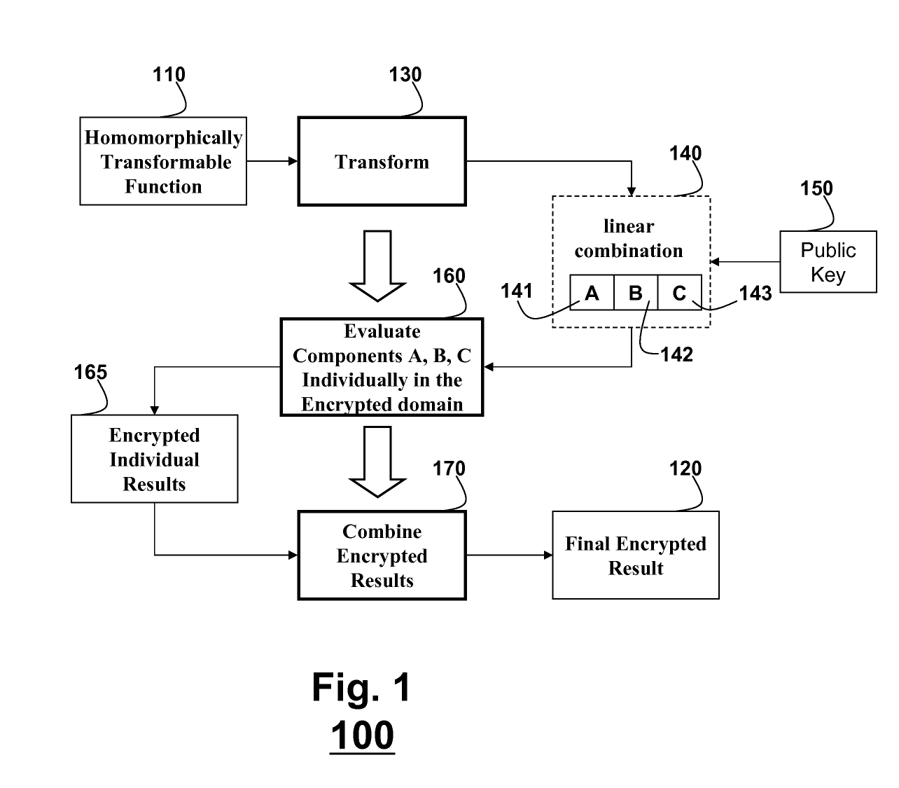

The FIG. 1 shows a method 100 for securely determining an encrypted result 120 of a homomorphically transformable function 110 applied to a first signal 210 and a second signal 215. The encrypted result can be securely communicated and decrypted with a private key associated with the public key 150.

The embodiments of the invention transform 130 the function 110 into a linear combination 140 of homomorphic components, e.g., 141, 142, and 143. Examples of the linear combination are addition and subtraction of the homomorphic components. The homomorphic components are encrypted with a public key 150. Using the encrypted signals, encrypted results of the homomorphic components are evaluated 160 individually. Because of properties of the homomorphic encryption and linear combination, encrypted individual results 165 can be combined 170 to produce the final encrypted result 120 of the function.

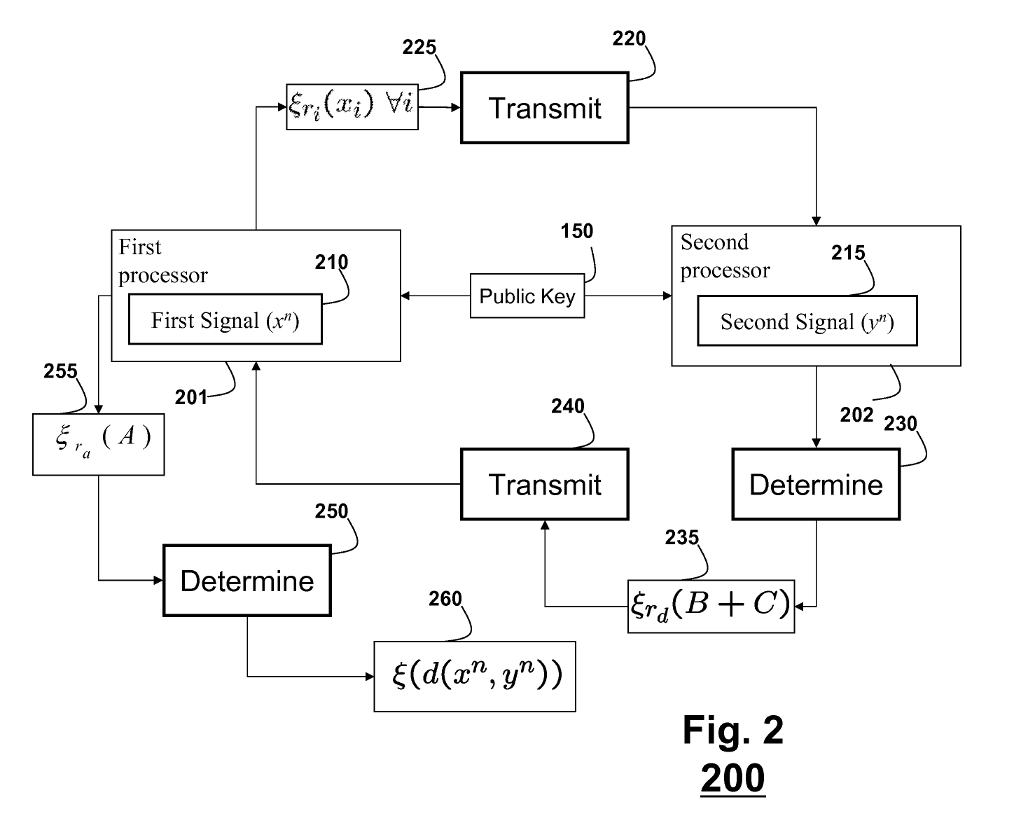

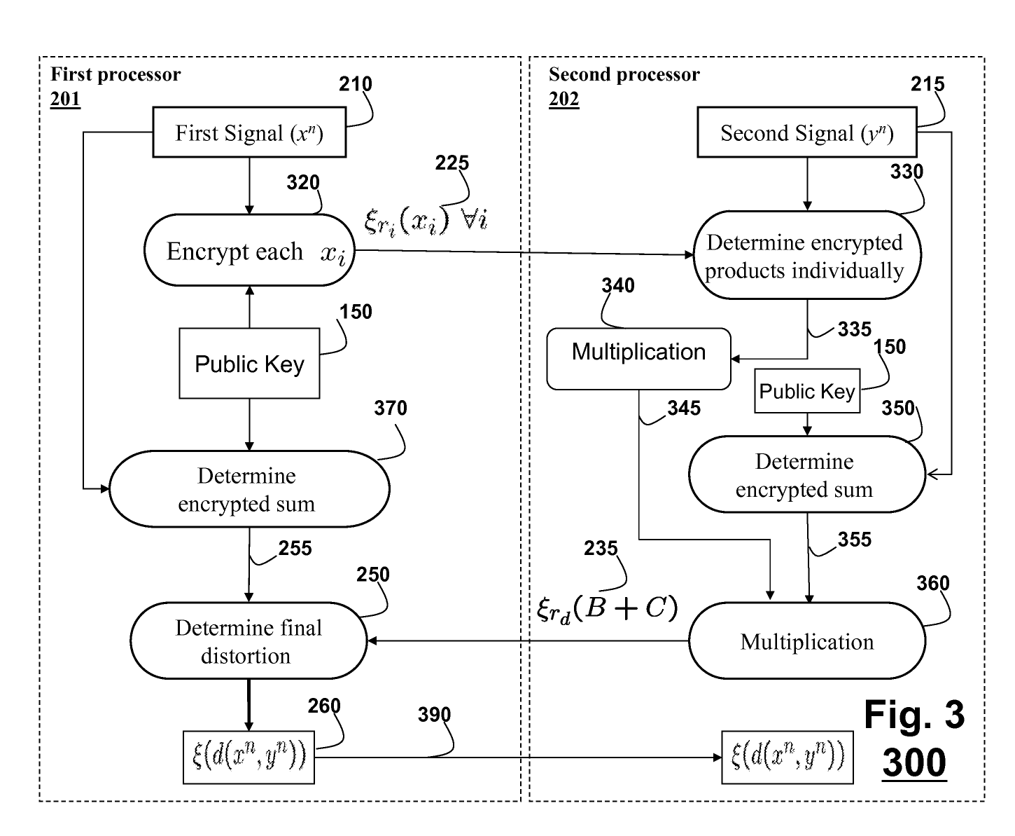

FIGS. 2-3 show a method for determining securely the result of a difference function applied to two signals according to an embodiment of the invention. In the embodiment, the system includes a first processor 201, and a second processor 202. It is understood that the invention can be worked with more than two signals and with one or plurality of processors.

The first processor stores a first signal xⁿ=(x₁, x₂, . . . , xₙ) 210, and the second processor stores a second signal yⁿ=(y₁, y₂, . . . , yₙ) 215, where n is the length of signals. The two processors do not share the signals with each other at any stage. As described below, in one embodiment, the function being evaluated is a Hamming distance function. In another embodiment, the function is a squared Euclidean distance function.

We tranform the function into a linear combination of three components A, B, and C, such that the first component A is a function of the first signal, the second component B is a function of the second signal, and the third component C is a linear function of a product of the first and the second signals.

Accordingly, the first processor can evaluated the first component A from the first signal xⁿ. The component A can be evaluated either from xⁿ or from encrypted xᵢ, i=1, 2, 3, . . . , n using homomorphic properties.

The second processor evaluates the second component B from the second signal yⁿ. The component B can be evaluated either from yⁿ or from an encrypted of yᵢ, i=1, 2, 3, . . . , n using homomorphic properties.

However, the two processors jointly evaluate the third component C in such a way that xⁿ is kept secret from the second processor and yⁿ is kept secret from the first processor. Embodiments of the invention use properties of the homomorphic encryption to determine securely the component C.

As shown in FIG. 2, the first processor 201 transmits 220 encrypted elements 225 of the first signal to the second processor 202. The second processor determines 230 a linear combination of the second and the third component 235 without decrypting the first signal as described in greater details below. The linear combination 235 of the second and the third components is transmitted 240 to the first processor. The first processor combines the combination 235 with the encrypted first component 255 to determined 250 the encrypted result 260.

Homomorphic Encryption

Homomorphic encryption is a form of encryption where an algebraic operation is performed on plaintext corresponds to another known algebraic operation performed on ciphertext. This property is useful because it enables computation using encrypted inputs to be performed directly in the encrypted domain, without the need for decrypting these inputs. Let P be a set of plaintexts associated with a binary operator·P, and H be a set of ciphertexts associated with a binary operator·H.

Definition 1.1

An encryption function ξ: P→H is homomorphic if, for all a, b ∈ P, ξ(a·P b)=ξ(a)·H ξ(b), where ξ is the encryption operator.

Many public-key cryptosystems use the homomorphic property. The embodiments of the invention work with a semantically secure homomorphic encryption scheme, e.g., Paillier homomorphic cryptosystem.

Paillier Homomorphic Cryptosystem

We describe a preferred embodiment that uses the Paillier homomorphic cryptosystem. The Paillier cryptosystem is a probabilistic asymmetric procedure for public key cryptography.

Configuration

Select two prime numbers p, q, and let N=pq. We select g ∈ [symbol] such that gcd (L(g^{λ}mod N²),N)=1, where λ=1 cm (p−1, q−1), and L(x)=(x−1)/N. Here, gcd refers to greatest common divisor and 1 cm refers to least common multiple. We use (N, g) as the public key, and (p, q) as the private key, and as described above, [symbol] is the set of nonnegative integers that have multiplicative inverses modulo N².

Encryption

Let m ∈ Z_{N} be plaintext. Then, the ciphertext is

c=ξ(m, r)=g^{m}·r^{N} mod N², (1)

where r ∈ [symbol] is a randomly selected integer, Z_{N}={0, 1, 2, . . . , N−1} and [symbol] is the set of nonnegative integers that have multiplicative inverses modulo N. The integer r is a parameter of the Paillier encryption function. The result of the encryption depends on this random parameter. If the message m is encrypted multiple times with different r, then the corresponding ciphertexts are different. Thus, the Paillier encryption is probabilistic in nature, as the encrypted value depends on the constant r, which is selected at random.

Decryption

Let c ∈ [symbol] be ciphertext. Then, the corresponding plaintext is

$$m = \frac{L ( \text{?} mod {N}^{2} )}{L ( \text{?} mod {N}^{2} )} mod N \\ \text{?} \text{indicates text missing or illegible when filed} \qquad ( 2 )$$

The function L(·) is defined as L(x)=(x−1)/N. The decryption gives the result m, irrespective of the value of r used during encryption.

The homomorphic property holds for the Paillier encryption function from the plaintext set (Z_{N},+) to the ciphertext set ( [symbol] , ·), i.e.,

ξ(m₁+m₂, r₁ r₂)=ξ(m₁, r₁)·ξ(m₂, r₂).

Thus, the encrypted value of a summation, is the product of encrypted values. In the above relation, r₁ and r₂ are parameters used in the Paillier encryption. As in Equation (1), these parameters are selected at random from the set Z*_{N}.

In addition to the above property, we also have the following property of Paillier Encryption:

ξ(m₁, r)^{m}₂=ξ(m₁ m₂, r).

Thus, the encrypted value of the product of two signals is obtained by an exponentiation of the encrypted values of one signal.

Secure Hamming Distance Evaluation

FIG. 3 shows the method for determining an encrypted difference measure 260 between a first signal 210 and a second signal 215 using a first processor 201 and a second processor 202.

The first processor stores the first signal xⁿ=(x₁, x₂, . . . , xₙ) 210, and the second processor stores the second signal yⁿ=(y₁, y₂, . . . , yₙ) 215. In one embodiment, the difference measure is defined by the Hamming distance function between binary vectors. We tranform the Hamming distance function d(xⁿ,yⁿ) of the signals xⁿ and yⁿ into a linear combination of homomorphic components

$$\begin{matrix} d ( \text{?} ) = {\sum }_{i = 1}^{n} ( \text{?} ) \\ = {\sum }_{i = 1}^{n} ( \text{?} - 2 \text{?} ) \\ = A + B + \text{?}\end{matrix} \\ \text{?} \text{indicates text missing or illegible when filed} \qquad ( 3 )$$

where [symbol] , and the operator ⊕ is modulo 2 addition.

The Hamming distance function of Equation (3) is a homomorphically transformable function, because a summation, i.e., an addition and a subtraction, of the components A, B, and C form the linear combination 140. The component A is a function of the first signal, the component B is a function of the second signal, and the component C is a linear function of a product of the first and the second signals.

The first processor encrypts 320 individual elements of the first signal using the public key 150 to produce a first set of encrypted elements 225 and transmits the set of encrypted elements to the second processor.

The second processor determines 330 encrypted products 335 of corresponding elements of the first set of encrypted elements and the second signal. For each l ∈ {1,2, . . . n}, the second processor determines

[symbol]

and

[symbol]

(4)

Next, the second processor determines 335, using the public key 150, an encrypted sum 340 of above encrypted products to produce a first encrypted summation 345:

[symbol]

(5)

where r_{c}=Πₗ₌₁ⁿ r₁ mod N, and Π is a product operator. The second processor operates only on encrypted values. Therefore, the values C and r_{c} are unknown to the second processor.

Next, the second processor sums 350 individual elements of the second signal to produce a second summation 355. The second processor sums 360 the second summation and the first encrypted summation to produce a third encrypted summation 235. The second processor selects r_{b} ∈ Z_{N}* at random and determine

ξᵣ_{_{d}}(B+C)≡ξᵣ_{_{b}}(B)ξᵣ_{_{c}}(C) mod N², (6)

where r_{d}=r_{b}r_{c} mod N ∈ Z_{N}*. The second processor transmits the third summation 235 to the first processor. The value of r_{d} is implicit in the encrypted calculation but is unknown to the second processor.

The first processor sums 370 individual encrypted elements of the first signal according to the key 150 to produce a fourth encrypted summation 375, and determines 280 an encrypted sum of the third encrypted summation and the fourth encrypted summation to produce the encrypted distortion 285. The first processor selects rₐ ∈ Z_{N}* at random and determines

$${ξ}_{r} ( d ( {x}^{n} , {y}^{n} ) ) = {ξ}_{r} ( A + B + C ) ≡ {ξ}_{{r}_{a}} ( A ) {ξ}_{{r}_{d}} ( B + C ) mod {N}^{2} \qquad ( 7 )$$

where r=rₐr_{d} mod N ∈ Z_{N}*,

In some embodiments, the encrypted difference measure 260 is transmitted 390 to the second processor.

Secure Squared Distance Calculation

In an alternative embodiment, the difference measure is a squared Euclidean distance function, i.e., the squared error, between the first signal xⁿ and the second signal yⁿ:

$$\begin{matrix} d ( \text{?} ) = {\sum }_{i = 1}^{n} {( \text{?} )}^{2} = {\sum }_{i = 1}^{n} ( \text{?} - 2 \text{?} ) = A + B + \text{?} , & ( 8 ) \\ where A = {\sum }_{i = 1}^{n} \text{?} , B = {\sum }_{i = 1}^{n} \text{?} , C = - {\sum }_{i = 1}^{n} 2 \text{?} . \\ \text{?} \text{indicates text missing or illegible when filed} & ( 8 )\end{matrix}$$

The squared Euclidean distance function of Equation (8) is a homomorphically transformable function, because the addition and the subtraction of the components A, B, and C form the linear combination 140, and the component A is a function of the first signal, the component B is a function of the second signal, and the component C is a linear function of a product of the first and the second signals.

In this embodiment, we substitute the values of the component A, B, and C in Equation (3) with corresponding values from Equation (8), and perform the method 300 without further modifications.

Private Fingerprint Authentication

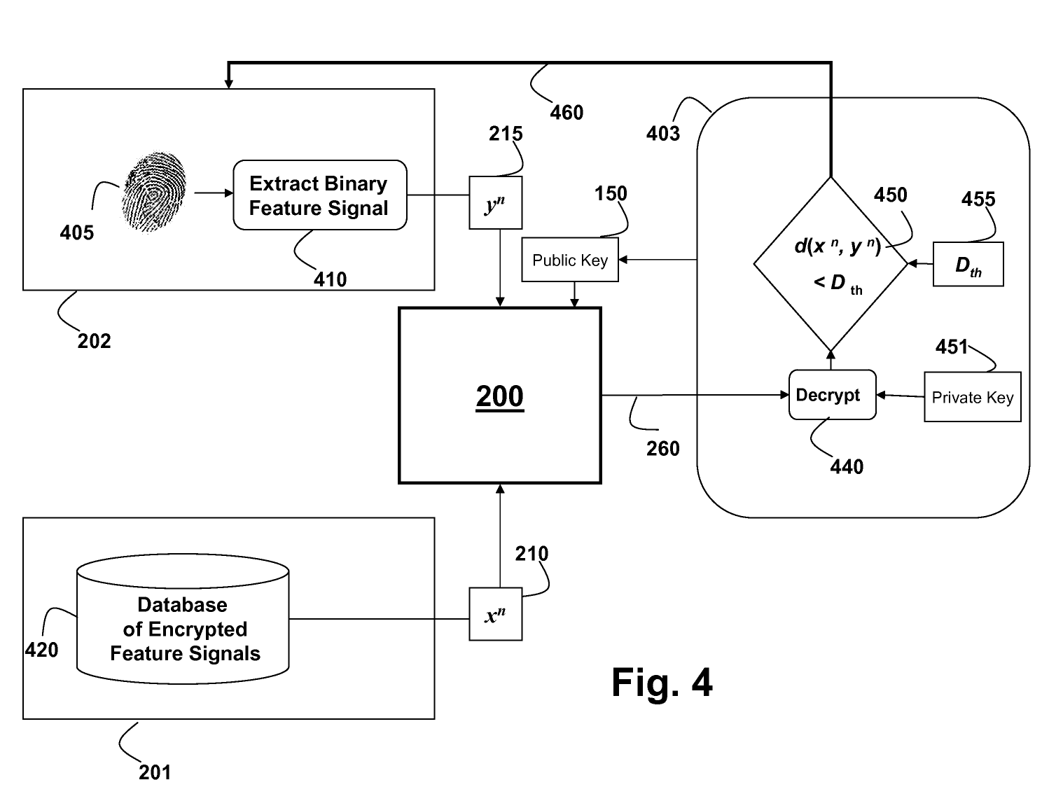

FIG. 4 shows a method for authenticating securely biometric data according to another embodiment of the invention. In this embodiment, the processors 201 and 202 interact with a third processor 403, e.g., a remote authentication server. The processor 202 keeps the biometric signal secret from the processor 201, and the processor 201 keeps the biometric database secret from processor 202.

The signal 215 is extracted 410 from an unknown biometric 405 such as a fingerprint. The remote authentication server 403 confirms the signal 215 if the signal matches at least one of the signals in the database 420, e.g., the signal 210, up to a threshold Dₜₕ 455, e.g., the Hamming distance.

The processors 201 and 202 determine the encrypted Hamming distance between the signals 215 and 210. The public key 150 is provided by the third processor 403. The encrypted difference 260 is transmitted to the third processor, and, after decrypting 440 with a private key 451, is compared 450 with the threshold. The result of comparison is transmitted 460 to the processor 202. In one implementation, the processor 201 further protects the database 420 by storing only encrypted fingerprints.

### EFFECT OF THE INVENTION

Embodiments of the invention use properties of homomorphic encryption to enable the two processors to compute a result of a function applied to two encrypted signals. In one embodiment, the function authenticates fingerprints, where a client interacts with a remote authentication server without revealing the fingerprint. The server performs authentication without revealing the fingerprints stored in the database at the server.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for determining a result of applying a function to a first encrypted signal and a second encrypted signal, wherein the first encrypted signal and the second encrypted signal resulted from encrypting a first signal and a second signal respectively, comprising a first processor and a second processor for performing steps of the method such that the first signal is kept secret from the second processor, and the second signal is kept secret from the first processor, comprising the steps:
expressing the function as a linear combination of homomorphic components, wherein each homomorphic component is an algebraic combination of the first signals and the second signal, such that the encrypted result of the algebraic combination is suitable to be determined directly from the first encrypted signal and the second encrypted signal using homomorphic properties of the algebraic combination;
determining the encrypted results of the homomorphic components from the first encrypted signal and the second encrypted signal; and
combining the encrypted results of the homomorphic components according to the linear combination to produce the encrypted result of the function such that a secrecy of the first signal and the second signal is preserved.

2. The method of claim 1, wherein the homomorphic components include a first function of the first signal, a second function of the second signal, and a linear function of a product of the first signal and the second signal.

3. The method of claim 1, wherein the function is a difference function, further comprising:
transforming the function into a summation of a first component, a second component, and a third component such that the first component is a function of the first signal, the second component is a function of the second signal, and the third component is a linear function of a product of the first and the second signals;
encrypting individually elements of the first signal with the key to produce a first set of encrypted elements, wherein the encrypting is performed by the first processor;
determining a linear combination of the second component and the third component based on the first set of encrypted elements and the second signal, wherein the determining is performed by the second processor in encrypted domain such that the linear combination is encrypted with the key; and
combining the linear combination with the first component encrypted with the key to produce the encrypted result of the function, wherein the combining is performed by the first processor.

4. The method of claim 1, wherein the function is a difference function, further comprising:
transforming the function into a summation of a first component, a second component, and a third component such that the first component is a function of the first signal, the second component is a function of the second signal, and the third component is a linear function of a product of the first and the second signals;
encrypting individually elements of the first signal with the key to produce a first set of encrypted elements;
determining encrypted products of corresponding elements of the first set of encrypted elements and the second signal;
determining an encrypted sum of the encrypted products to produce a first encrypted summation;
summing elements of the second signal in encrypted domain to produce a second encrypted summation;
multiplying the second encrypted summation and the first encrypted summation to produce a third encrypted summation;
summing elements of the first signal in encrypted domain according to the key to produce a fourth encrypted summation; and
determining a product of the third encrypted summation and the fourth encrypted summation to produce the encrypted result.

5. The method of claim 4, further comprising:
storing the first signal at a first processor; and
storing the second signal at a second processor.

6. The method of claim 5, further comprising:
transmitting the set of encrypted elements from the first processor to the second processor; and
transmitting the third encrypted summation from the second processor to the first processor.

7. The method of claim 4, further comprising:
transmitting the encrypted result from the first processor to a third processor;
comparing the encrypted result with a threshold to produce a result of authentication; and
authenticating the second signal based on the result of authentication.

8. The method of claim 7, further comprising:
decrypting the encrypted result by the third processor.

9. The method of claim 7, wherein the second signal is extracted from an unknown fingerprint, and wherein the first signal represents a known fingerprint.

10. The method of claim 4, wherein the first signal is xⁿ={x₁, x₂, . . . , xₙ}, the second signal is yⁿ={y₁, y₂, . . . , yₙ}, and wherein N=pq, and p and q are prime numbers, and wherein the difference function is a Hamming distance function d(. , .), and wherein the transforming is according to
$$\begin{matrix}d ( {x}^{n} , {y}^{n} ) = {\sum }_{i = 1}^{n} ( {x}_{i} ⊕ {y}_{i} ) \\ = {\sum }_{i = 1}^{n} ( {x}_{i} + {y}_{i} - 2 {x}_{i} {y}_{i} ) \\ = A + B + C ,\end{matrix}$$
$$where$$
$$A = {\sum }_{i = 1}^{n} {x}_{i} , \\ B = {\sum }_{i = 1}^{n} {y}_{i} , \\ C = - {\sum }_{i = 1}^{n} 2 {x}_{i} {y}_{i} , and i is an index i ∈ 1 , 2 , … , n ,$$
wherein A is the first component, B is the second component, C is the third component, and ⊕ is the binary XOR operator.

11. The method of claim 4, wherein the first signal is xⁿ={x₁, x₂, . . . , xₙ}, the second signal is yⁿ={y₁, y₂, . . . , yₙ}, and wherein, N=pq, and p and q are prime numbers, and wherein the function is a squared Euclidean distance function d(. , .), and wherein the transforming is according to
$$\begin{matrix}d ( {x}^{n} , {y}^{n} ) = {\sum }_{i = 1}^{n} {( {x}_{i} - {y}_{i} )}^{2} \\ = {\sum }_{i = 1}^{n} ( {x}_{i}^{2} + {y}_{i}^{2} - 2 {x}_{i} {y}_{i} ) \\ = A + B + C ,\end{matrix}$$
$$where$$
$$A = {\sum }_{i = 1}^{n} {x}_{i}^{2} , \\ B = {\sum }_{i = 1}^{n} {y}_{i}^{2} , \\ C = - {\sum }_{i = 1}^{n} 2 {x}_{i} {y}_{i} , and i is an index i ∈ 1 , 2 , … , n ,$$
wherein A is the first component, B is the second component, and C is the third component.

12. The method of claim 10, comprising:
encrypting the elements xᵢ with the key according to ξᵣᵢ(xᵢ)∀ i, wherein rᵢ is a random number;
determining the encrypted products according to
\tilde{y}ᵢ=−2yᵢ mod N
ξᵣ_{ᵢ}(−2xᵢyᵢ)≡[ξᵣ_{ᵢ}(xᵢ)]^{\tilde{y}}^{ᵢ} mod N²,
where ξ is an encryption operator;
determining the encrypted sum of the encrypted products according to
$${ξ}_{{r}_{c}} ( C ) = {ξ}_{{r}_{c}} ( - {\sum }_{i = 1}^{n} 2 {x}_{i} {y}_{i} ) ≡ {\prod }_{i = 1}^{n} {ξ}_{{r}_{i}} ( - 2 {x}_{i} {y}_{i} ) mod {N}^{2} ,$$
where r_{c}=Πᵢ₋₁ⁿrᵢ mod N ∈ Z_{N}*, Π is a product operator, and Z_{N}* is a set of nonnegative integers having multiplicative inverses modulo N;
summing the second summation and the first encrypted summation according to
ξᵣ_{_{d}}(B+C)≡ξᵣ_{_{b}}(B)ξᵣ_{_{c}}(C) mod N²,
where r_{d}=r_{b}r_{c} mod N ∈ Z_{N}*, and r_{b} is selected at random such that r_{b} ∈ Z_{N}*; and
determining the encrypted result according to
ξᵣ(d(xⁿ, yⁿ))=ξᵣ(A+B+C)≡ξᵣ_{ₐ}(A)ξᵣ_{_{d}}(B+C) mod N²,
where r=rₐr_{d} mod N ∈ Z_{N}*, and rₐ is selected at random such that rₐ ∈ Z_{N}*.

13. A system for determining a result of applying a function to a first encrypted signal and a second encrypted signal, wherein the first encrypted signal and the second encrypted signal resulted from encrypting a first signal and a second signal respectively, comprising a first processor and a second processor for performing steps of the method such that the first signal is kept secret from the second processor, and the second signal is kept secret from the first processor, comprising the steps:
means for expressing the function as a linear combination of homomorphic components, wherein a homomorphic component is an algebraic combination of the first signals and the second signal such that an encrypted result of the algebraic combination is suitable to be calculated directly from the first encrypted signal and the second encrypted signal using homomorphic properties;
means for determining encrypted results of the homomorphic components from the first encrypted signal and the second encrypted signal; and
means for combining the encrypted results of the homomorphic components according to the linear combination to produce the encrypted result of the function.

14. The system of claim 13, wherein the homomorphic components include a function of the first signal, a function of the second signal, and a linear function of a product of the first signal and the second signal.

15. The system of claim 13, wherein the function is a difference function, further comprising:
means for transforming the function into a summation of a first component, a second component, and a third component such that the first component is a function of the first signal, the second component is a function of the second signal, and the third component is a linear function of a product of the first and the second signals;
means for encrypting individually elements of the first signal with the key to produce a first set of encrypted elements, wherein the encrypting is performed by a first processor;
means for determining a linear combination of the second component and the third component based on the first set of encrypted elements and the second signal, wherein the determining is performed by a second processor in encrypted domain such that the linear combination is encrypted with the key; and
means for combining the linear combination with the first component encrypted with the key to produce the encrypted result of the function, wherein the combining is performed by the first processor.

16. The system of claim 13, wherein the function is a difference function, further comprising:
means for transforming the function into a summation of a first component, a second component, and a third component such that the first component is a function of the first signal, the second component is a function of the second signal, and the third component is a linear function of a product of the first and the second signals;
means for encrypting individually elements of the first signal with the key to produce a first set of encrypted elements;
means for determining encrypted products of corresponding elements of the first set of encrypted elements and the second signal;
means for determining an encrypted sum of the encrypted products to produce a first encrypted summation;
means for summing elements of the second signal to produce a second summation;

17. A method for determining an encrypted result of a function of a plurality of encrypted signals corresponding to a plurality of unencrypted signals, the plurality of the encrypted signals is associated respectively with a plurality of processors such that each corresponding unencrypted signal is secret from unassociated processors, comprising a processor for performing steps of the method, comprising the steps:
expressing the function as a linear combination of homomorphic components, wherein a homomorphic component is an algebraic combination of the plurality of unencrypted signals such that an encrypted result of the algebraic combination is suitable to be calculated directly from the plurality of the encrypted signals using homomorphic properties;
determining the encrypted results of the homomorphic components from the plurality of encrypted signals; and
combining the encrypted results of the homomorphic components according to the linear combination to produce the encrypted result of the function.
